(19) United States
(12) Patent Application Publication
(10) Pub. No.: US 2024/0242419 A1
(43) Pub. Date: Jul. 18, 2024

(54) METHOD OF CREATING A VOLUMETRIC TEXTURE FOR A 3D MODEL OF A PHYSICAL OBJECT

(71) Applicant: Hyperforge Holdings Pte Ltd., Singapore (SG)

(72) Inventor: Michael GALLO, Valeggio sul Mincio (IT)

(21) Appl. No.: 18/606,547

(22) Filed: Mar. 15, 2024

Related U.S. Application Data
(63) Continuation of application No. PCT/EP2022/068960, filed on Jul. 7, 2022.

(30) Foreign Application Priority Data
Sep. 16, 2021 (DE) 10 2021 124 017.4

(51) Int. Cl. G06T 15/04; G06T 15/10; G06T 17/00; G06T 19/20

(52) U.S. Cl. CPC G06T 15/04; G06T 15/10; G06T 17/00; G06T 19/20; G06T 2219/2021

(57) ABSTRACT

A method is provided for generating a volumetric texture for a 3D model of a physical object.

### CROSS REFERENCE TO RELATED APPLICATIONS

This application is a continuation under 35 U.S.C. § 120 of International Application PCT/EP2022/068960, filed Jul. 7, 2022, which claims priority to German Application No. 10 2021 124 017.4, filed Sep. 16, 2021, the contents of each of which are incorporated by reference herein.

### FIELD OF THE INVENTION

The invention relates to methods for generating a volumetric texture for a 3D model of a physical object.

### BACKGROUND OF THE INVENTION

It is known to process boundary-surface models with regard to their appearance. For this purpose, textures, in particular two-dimensional image textures, are usually applied to the surface of a 3D model in visualization programs. By changing the surface, or boundary surface, of the 3D model, the surface of the object can be enriched by details without thereby increasing the complexity of the object geometry. For example, the color of the surface can be changed, the normal vector of surface portions, or the surface can even be displaced in portions.

3D effects can be simulated in particular by adapting the normal vector of surface portions of an object. This visualization technique is also known as “bump mapping.” Bump mapping can be used, for example, to simulate a rough surface on the 3D model of an object, even though the surface itself is smooth.

With regard to 3D printing, however, the usual methods for bump mapping an object have the disadvantage that the simulated 3D effects only exist virtually; i.e. they are missing from the physical, 3D-printed object, or cannot be printed. This is because the normal vector of a surface can be changed or adjusted only in a simulation, but not in the case of a real surface of a physical object in the real world.

### OBJECT OF THE INVENTION

The object of the present invention is therefore to provide methods by means of which bump mapping of real physical objects is made possible, wherein the real physical object is produced by a 3D printing process.

### SOLUTION ACCORDING TO THE INVENTION

The object is achieved by a method having the features according to the independent claim 1. Advantageous developments of the invention are defined in the dependent subclaims.

According to the invention, a method for generating a volumetric texture for a 3D model of a physical object is provided. The 3D model comprises a triangulated surface with a plurality of first triangles. Each first triangle of the plurality of first triangles has a surface normal. Each corner of each first triangle of the plurality of first triangles has first texture coordinates and a corner normal.

For each first triangle, in a first step a first plane is generated parallel to the first triangle at a first specified distance along the surface normal of the first triangle.

In a second step, a second triangle projected onto the first plane by means of the corner normal of the first triangle is generated.

In a third step, a volume region is generated. The volume region has a number of second voxels and comprises the first triangle and the second triangle; i.e., the first triangle and the second triangle lie within the volume region. The volume region thus surrounds the number of second voxels and the first triangle.

In a fourth step, iteration is carried out over the number of second voxels, wherein a first distance of the corresponding second voxel from the first triangle is calculated and a third triangle, projected on a second parallel plane spaced apart by the first distance, is generated. Second texture coordinates are assigned to each corner of the third triangle. Third texture coordinates are derived from the second texture coordinates for the corresponding second voxel.

In a fifth step, a voxel model is generated. The voxel model comprises first voxels. The second voxels correspond to the first voxels. The third texture coordinates and the first distance of the at least one second voxel are assigned to the corresponding first voxels as 3D coordinates. As a result, the voxel model represents the volumetric texture of the 3D model.

The method according to the invention can be applied to 3D models with any triangulated surface and is therefore versatile in its use. A volumetric texture represented by a voxel model has a number of advantages.

Firstly, the volumetric texture can be modeled with almost any level of detail. Each voxel of the voxel model of the volumetric texture can have different materials or different colors or can differ in other manufacturing parameters. In this way, a digital bump mapping applied to a 3D model in conventional visualization programs can be transferred to real physical objects from the 3D printer.

Secondly, voxel models can be processed extremely efficiently and robustly, i.e. without numerical instabilities. For example, processing operations of the voxel model can be parallelized and/or accelerated by means of binary computing operations. A volumetric texture represented by a voxel model can thus be processed considerably faster and more efficiently than a volumetric texture represented by a polygon-based model.

Thirdly, the method according to the invention is based on geometric operations that are easy to perform and not very computationally intensive, such as opening out a parallel plane or calculating intersection points of corner normals with the parallel plane. The method thus enables an efficient generation of second voxels and calculation of their texture coordinates. The method according to the invention can accordingly also be applied to larger boundary surface models or surfaces of objects.

It is advantageous, in a union step, to determine a union set of the second voxels of all volume regions in order to remove overlapping second voxels. Overlapping second voxels arise in particular in the case of adjacent first triangles of a concave surface portion of the 3D model.

The advantage of forming a union set of the second voxels of all volume regions is that overlapping second voxels are eliminated, which increases the efficiency of processing the volumetric texture in two aspects: the processing of the volumetric texture is accelerated, and less memory is required to store the resulting voxel model, i.e. the volumetric texture.

It is also advantageous if the voxel model is applied to the 3D model of the physical object in a transformation step. For this purpose, the 3D texture coordinates of the first voxels of the voxel model are transformed into Cartesian coordinates X, Y and Z.

By applying the voxel model to the 3D model, the 3D model, including the volumetric texture, can be produced in a 3D printer. In this way, digital visualization effects, such as rough or patterned surfaces, can be realized on a physical object in almost any level of detail.

In an advantageous aspect of the invention, a distance attribute is assigned to each first voxel of the voxel model, wherein a second distance is assignable to the distance attribute. The second distance is measured between the corresponding first voxel and a second surface of the physical object terminating the volumetric texture.

An envelope of constant thickness is not usually placed over the surface of an object as a volumetric texture, but rather an envelope whose thickness varies locally. It is therefore advantageous to assign to each voxel a distance to the resulting surface of the physical object by means of a distance attribute, i.e. the surface which results from application of the volumetric texture to the original physical object.

It is advantageous to assign a second specified distance to the distance attribute of selected first voxels in order to form the volumetric texture.

In an advantageous aspect of the method according to the invention, those second voxels are discarded whose first distance from the first triangle is negative or greater than the first specified distance.

Voxels which lie below the surface of the object or far outside the volumetric texture to be applied can thereby be eliminated. The number of second voxels is thus reduced to those second voxels which are required to generate the volumetric texture.

Advantageously, the second voxels of which one of the third texture coordinates is negative are discarded.

A further limitation of the number of second voxels to those which are minimally required to represent the volumetric texture has the technical advantage that the complexity of the voxel model is considerably reduced. This results in a faster or more efficient processing of the voxel model.

Furthermore, it is advantageous if the second voxels of the volume region are each aligned identically, i.e. in parallel, for each of the first triangles.

The spatial alignment of the volume regions can define the spatial alignment of the second voxels. It is thus advantageous to align all the volume regions in parallel. Second voxels aligned in parallel make it easier to process the voxel model as a whole. For example, binary operations such as forming a union set can be performed more efficiently with second voxels aligned in parallel.

Advantageously, in the fourth step the third texture coordinates are calculated as barycentric coordinates in the third triangle.

It is further advantageous if in the fourth step the third texture coordinates (U_{V}; V_{V}) are calculated by means of trilinear interpolation between second voxels (VX2).

### BRIEF DESCRIPTION OF THE FIGURES

Further details and features of the method according to the invention, as well as specific, in particular advantageous embodiments of the method according to the invention result from the following description in conjunction with the drawings. In the figures:

FIG. 1 shows an exemplary embodiment of the first step of the method according to the invention;

FIG. 2 shows an exemplary embodiment of the second step of the method according to the invention;

FIG. 3 shows an exemplary embodiment of the third step of the method according to the invention;

FIG. 4 shows an exemplary embodiment of the first part of the fourth step of the method according to the invention;

FIG. 5 shows an exemplary embodiment of the second part of the fourth step of the method according to the invention; and

FIG. 6 shows a flow chart of an embodiment of the method according to the invention.

### DETAILED DESCRIPTION OF THE INVENTION

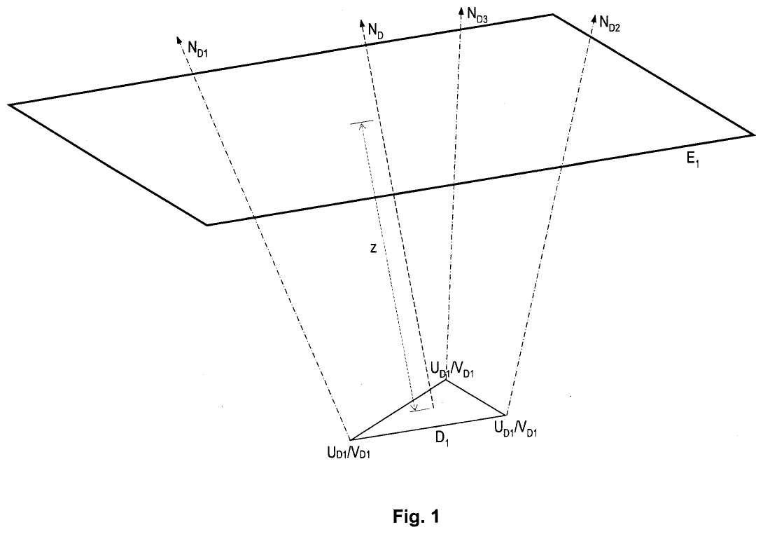

FIG. 1 illustrates the execution of the first step of the method according to the invention.

The 3D model of a physical object for which a volumetric texture is to be generated comprises a triangulated surface with a plurality of first triangles. For example, the surface of the physical object can be represented by a triangulated irregular network (TIN). Here two adjacent first triangles each share an edge and two corner points, so that the surface of the physical object is represented by a network of non-overlapping first triangles.

The method according to the invention is explained below on the basis of such a first triangle D1 shown in FIG. 1, wherein the method is applied correspondingly for all triangles of the surface. In one embodiment of the invention, however, the method can also be used for only a subset of the triangles of the surface, for example if only one side of a 3D model is to be provided with a volumetric texture.

Each corner of each first triangle D1 has first texture coordinates U_{D1}; V_{D1}. The texture coordinates are usually generated by a UV mapping. UV mapping is the process by which a 2D image of the surface of a 3D model is generated. Accordingly, the 2D image represents an unfolded network structured by triangles. The corner points of the triangles, i.e. the nodes in the unfolded network, are assigned 2D texture coordinates U_{D1}; V_{D1}, wherein each of the texture coordinates usually has a value in the interval between zero and one.

Each first triangle D1 has a surface normal ND.

Furthermore, each corner of each first triangle has a corner normal N_{D1}, N_{D2}, N_{D3}. Depending on the curvature of the surface of the physical object, in a corner divided by two adjacent first triangles D1 the corner normal N_{D1} of the one triangle may deviate from the corner normal N_{D1} of the neighboring triangle.

As shown in FIG. 1, in the first step S1 a first plane E1 parallel to the first triangle D1 is generated at a first specified distance z along the surface normal ND of the first triangle. The first specified distance z can determine the maximum thickness of the volumetric texture. The aim of the following steps is to generate a voxel structure between the first plane E1 and the first triangle D1, wherein texture coordinates are assigned to the voxels.

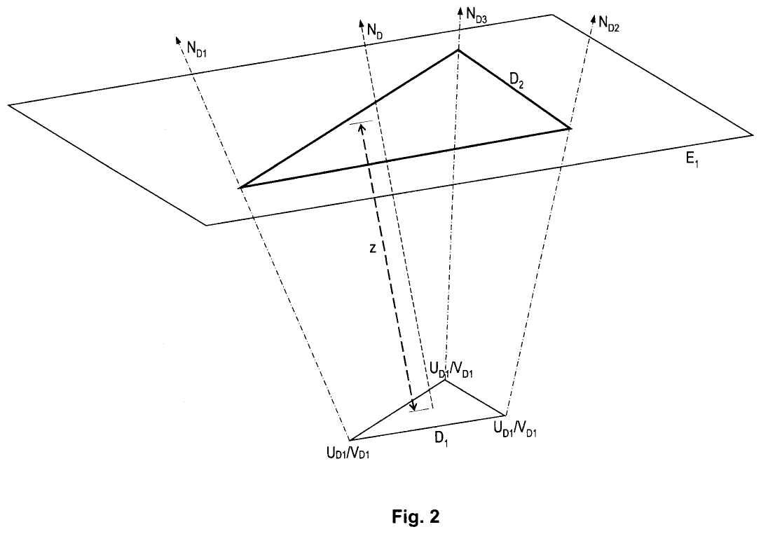

FIG. 2 illustrates an embodiment of the second step of the method according to the invention.

In the second step S2, a second triangle D2 projected onto the first plane E1 by means of the corner normals N_{D1}; N_{D2}; N_{D3} of the first triangle D1 is generated.

The three corner points of the second triangle D2 result from the points of intersection of the corner normals N_{D1}; N_{D2}; N_{D3} with the first plane E1. The second triangle D2 is thus aligned parallel to the first triangle D1 at the first specified distance z. Depending on the orientation of the corner normals N_{D1}; N_{D2}; N_{D3}, the second triangle D2 can have an area (not shown) of the same size as the first triangle D1, a larger area (as shown in FIG. 2) than the first triangle D1, or a smaller area (not shown) than the first triangle D1, wherein the angles of the first triangle D1 can also differ from the angles of the second triangle D2.

In the following steps of the method according to the invention, a voxel structure is to be generated in the volume of a truncated pyramid or prism with a triangular base between the first triangle D1 and the second triangle D2.

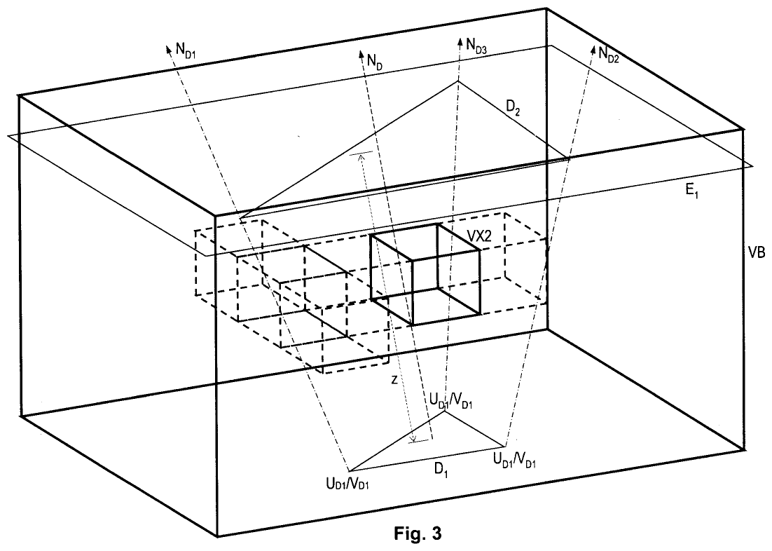

FIG. 3 illustrates an embodiment of the third step of the method according to the invention.

In the third step S3, a volume region VB is generated, wherein the volume region VB has a number of second voxels VX2. Furthermore, the volume region VB comprises the first triangle D1 and the second triangle D2; i.e., the first triangle D1 and the second triangle D2 are enclosed in this volume region.

The volume region VB can be generated in any size and orientation, as long as it comprises or encloses the first triangle D1 and the second triangle D2. The volume region VB has a number of second voxels VX2. It is expedient if the second voxels VX2 of the volume region VB are aligned parallel to the first triangle D1 and thus to the first plane E1. It is also advantageous if the volume region VB is defined or represented by the number of second voxels VX2. In FIG. 3, a number of second voxels VX2 are denoted by dashed edges. By contrast, the selected second voxel VX2, on the basis of which the following steps of the method according to the invention are explained in more detail, is shown with solid lines.

The second voxels VX2 act as aids for determining the texture coordinates of those voxels which represent the volumetric texture. The aim of the following method steps is therefore to characterize the second voxels VX2 of the volume region VB, i.e. to determine the texture coordinates of each second voxel in relation to the surface of the physical object. The information obtained can finally be assigned to a voxel model VM which represents the volumetric texture.

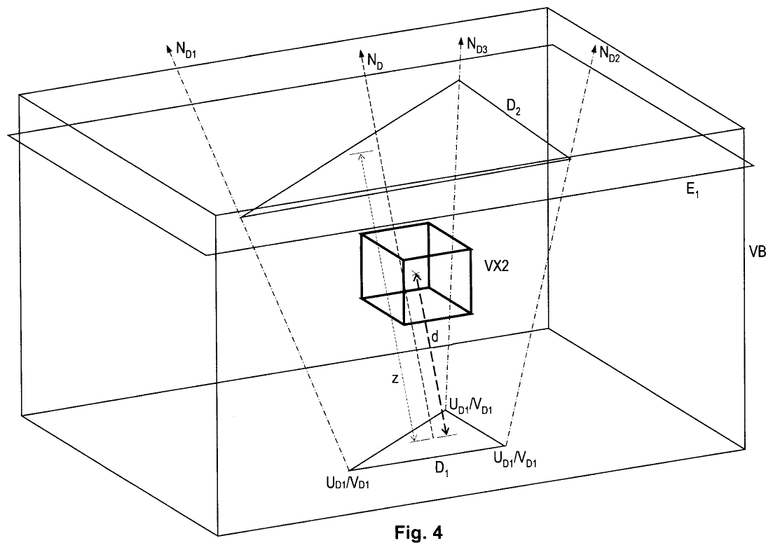

FIG. 4 illustrates an embodiment of a first part of the fourth step of the method according to the invention.

In the fourth step S4 of the method according to the invention, iteration is carried out over the number of second voxels VX2 of the volume region VB.

In the first part S4.1 of the fourth step S4, a first distance d of the corresponding second voxel VX2 from the first triangle D1 is calculated. The first distance d accordingly indicates the distance of a second voxel VX2 from the surface portion under consideration of the physical object. Preferably, the minimum distance in terms of magnitude between the respective second voxel VX2 and the first triangle D1 is calculated.

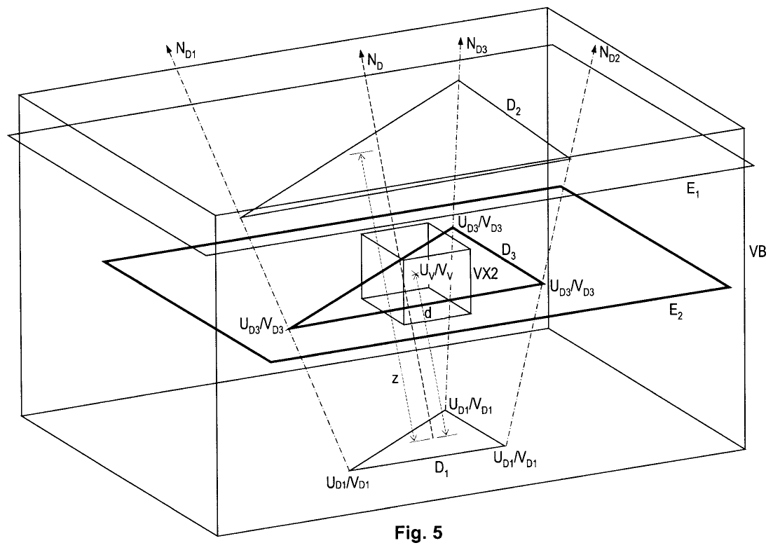

FIG. 5 illustrates an embodiment of the second part S4.2 of the fourth step S4 of the method according to the invention.

In the second part S4.2 of the fourth step S4, a third triangle D3 is generated on a second plane E2 which is parallel to the first triangle D1 and which is spaced apart from the first triangle D1 by the first distance d.

First, a second plane E2 is thus generated at the first distance d from the first triangle D1. The second plane E2 generated here is marked in bold in FIG. 5. The corner points of the third triangle are given by the points of intersection of the corner normals N_{D1}; N_{D2}; N_{D3} with the second plane E2. Each corner of the third triangle D3 is assigned second texture coordinates U_{D3}; V_{D3}. The second texture coordinates U_{D3}; V_{D3} here result from the first texture coordinates U_{D1}; V_{D1} of the first triangle D1.

From the second texture coordinates U_{D3}; V_{D3}, third texture coordinates U_{V}; V_{V} are derived for the respective second voxel VX2. Preferably, the third texture coordinates U_{V}; V_{V} are calculated as barycentric coordinates in the third triangle D3. The third texture coordinates U_{V}; V_{V} thus indicate the position of the second voxel VX2 in each case in relation to the corner points of the third triangle D3 in the second plane E2.

It is advantageous if those second voxels VX2 are discarded whose first distance d from the first triangle D1 is negative or greater than the first specified distance z. Preferably, those second voxels VX2 are also discarded of which one of the third texture coordinates U_{V}; V_{V} is negative.

Preferably, in the second part S4.2 of the fourth step S4 the third texture coordinates U_{V}; V_{V} of the second voxels VX2 can be calculated by means of trilinear interpolation between second voxels (VX2). The second voxels VX2 of a volume region VB preferably form a regular three-dimensional grid on which the values for the third texture coordinates U_{V}; V_{V} can be interpolated trilinearly.

After performance of the fourth step of the method according to the invention, the second voxels VX2 therefore fill the volume of the truncated pyramid or prism with a triangular base surface between the first triangle D1 and the second triangle D2. Each second voxel VX2 has third texture coordinates U_{V}; V_{V} and a first distance d from the first triangle D1.

In a fifth step S5 of the method according to the invention, a voxel model VM is generated. The voxel model VM comprises first voxels VX1, wherein the second voxels VX2 correspond to the first voxels VX1. The third texture coordinates U_{V}; V_{V} and the first distance d of the second voxels VX2 are assigned as 3D texture coordinates U; V; W to the corresponding first voxels VX1. For example, the third texture coordinates U_{V}; V_{V} and the first distance d of the second voxels VX2 are copied to the corresponding first voxels VX1. The voxel model VM thus represents the volumetric texture of the 3D model of the physical object.

Preferably, before the generation of the voxel model VM, in a union step of the method according to the invention a union set is determined of the second voxels VX2 of all volume regions VB in order to remove overlapping second voxels VX2.

Due to the different orientation of corner normals of adjacent first triangles D1 in divided corner points, overlapping truncated pyramids with a triangular base can result, and thus overlapping second voxels VX2. It is true that the third texture coordinates U_{V}; V_{V} of the overlapping second voxels may differ as a rule, since the third texture coordinates U_{V}; V_{V} relate to different third triangles D3 in this case. However, overlapping second voxels VX2 represent (at least partially) the same spatial unit twice, of which half can be saved, and thus the processing efficiency can be increased.

Preferably, the voxel model is applied to the 3D model of the physical object in a seventh step S7 of the method according to the invention.

It is particularly advantageous if a distance attribute is assigned to each first voxel VX1 of the voxel model, wherein a second distance d2 can be assigned to the distance attribute. The second distance d2 is measured between the corresponding first voxel VX1 and a second surface, terminating the volumetric texture, of the physical object. It is provided that the surface of the volumetric texture runs within the first specified distance z from the surface of the physical object.

The volumetric texture or its surface can advantageously be formed in that a second specified distance die is assigned to the distance attribute of selected first voxels VX1. It is provided that the second specified distance ds indicates that the corresponding first voxels VX1 lie outside the volumetric texture. Thus, by manipulating the distance values of the first voxels VX1, a volumetric texture can be generated with any desired level of detail, by means of which a bump mapping for a physical object can be generated from the 3D printer.

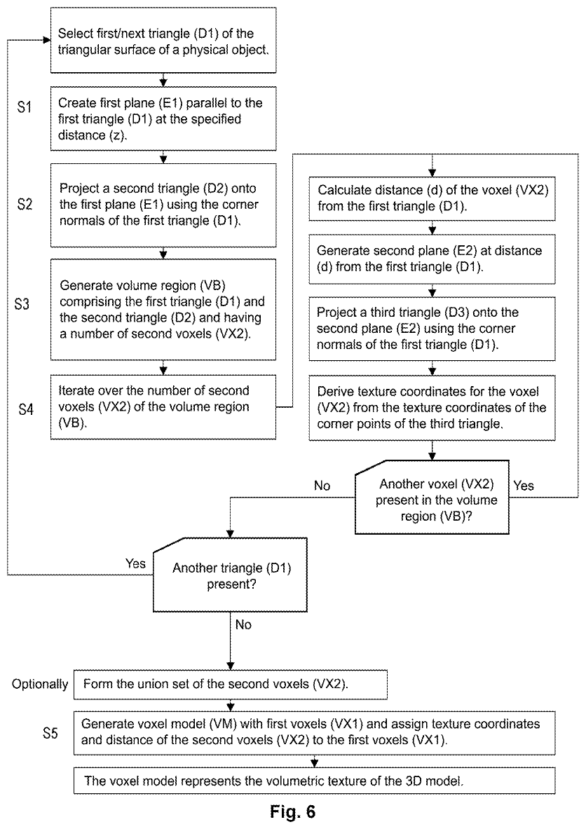

FIG. 6 shows a flow chart of an embodiment of the method according to the invention.

The above embodiments of the individual steps of the method according to the invention are put into relation to each other and summarized by the flow chart of FIG. 6.

For each first triangle D1 of the triangulated surface of a 3D model of a physical object, method steps S1 to S4 are carried out in the order shown in FIG. 6. Step S4 here comprises an iteration over the second voxels VX2 of the corresponding volume region VB.

After third texture coordinates U_{V}; V_{V} have been calculated for every second voxel VX2 of each volume region VB, i.e. for every first triangle D1, in the fifth step S5 a voxel model VM is first generated. The voxel model comprises first voxels VX1 as described above. Next, the third texture coordinates UV; VV and the first distance d of the second voxels VX2 are to be assigned to the corresponding first voxels VX1 as 3D texture coordinates.

Preferably, a union set of the second voxels VX2 as described above can be formed in a union step, in particular before the assignment of the 3D texture coordinates U; V; W.

The generated voxel model VM represents the volumetric texture of the 3D model of a physical object.

In a transformation step (not shown), the triangulated surface and the volumetric texture can be transformed into a Cartesian coordinate system, so that a 3D model with applied volumetric texture results. Control instructions for a 3D printer can be derived from the resulting 3D model, which can be used to print the physical object enriched by bump mapping.

1. A method for generating a volumetric texture for a 3D model of a physical object, wherein
the 3D model comprises a triangulated surface having a plurality of first triangles (D1),
each first triangle (D1) has a surface normal (ND),
each corner of each first triangle (D1) has first texture coordinates (U_{D1}; V_{D1}) and a corner normal (N_{D1}; N_{D2}; N_{D3}), and
wherein for each first triangle (D1):
in a first step (S1), a first plane (E1) parallel to the first triangle (D1) is generated at a first specified distance (z) along the surface normal (ND) of the first triangle (D1),
in a second step (S2), a second triangle (D2) projected onto the first plane (E1) by means of the corner normals (N_{D1}; N_{D2}; N_{D3}) of the first triangle (D1) is generated,
in a third step (S3), a volume region (VB) is generated, wherein the volume region (VB) has a number of second voxels (VX2) and comprises the first triangle (D1) and the second triangle (D2),
in a fourth step (S4), iteration takes place over the number of second voxels (VX2), wherein
a first distance (d) of the corresponding second voxel (VX2) from the first triangle (D1) is calculated, and
a third triangle (D3) is generated on a second plane (E2) which is parallel to the first triangle (D1) and is spaced apart from the first triangle (D1) by the first distance (d), wherein
each corner of the third triangle (D3) is assigned second texture coordinates (U_{D3}; V_{D3}), and
third texture coordinates (U_{V}; V_{V}) are derived from the second texture coordinates (U_{D3}; V_{D3}) for the respective second voxel (VX2), and
in a fifth step (S5), a voxel model (VM) is generated, wherein the voxel model comprises first voxels (VX1), wherein the second voxels (VX2) correspond to the first voxels (VX1), and the third texture coordinates (U_{V}; V_{V}) and the first distance (d) of the second voxels (VX2) are assigned as 3D texture coordinates (U; V; W) to the corresponding first voxels (VX1), so that the voxel model (VM) represents the volumetric texture of the 3D model.

2. The method of claim 1, wherein in a union step, a union set of the second voxels (VX2) of all volume regions (VB) is determined in order to remove overlapping second voxels (VX2).

3. The method of claim 1, wherein the voxel model (VM) is applied to the 3D model of the physical object in a transformation step.

4. The method of claim 3, wherein a distance attribute is assigned to each first voxel (VX1) of the voxel model, wherein a second distance (d2) is assignable to the distance attribute, wherein the second distance (d2) is measured between the corresponding first voxel (VX1) and a second surface of the physical object terminating the volumetric texture.

5. The method of claim 4, wherein a second specified distance (d_{+∞}) is assigned to the distance attribute of selected first voxels (VX1) to form the volumetric texture.

6. The method of claim 1, wherein those second voxels (VX2) whose first distance (d) from the first triangle (D1) is negative or greater than the first specified distance (z) are discarded.

7. The method of claim 1, wherein those second voxels (VX2) of which one of the third texture coordinates (U_{V}; V_{V}) is negative are discarded.

8. The method of claim 1, wherein the second voxels (VX2) of the volume region (VB) are each aligned identically for each of the first triangles (D1).

9. The method of claim 1, wherein in the fourth step the third texture coordinates (U_{V}; V_{V}) are calculated as barycentric coordinates in the third triangle (D3).

10. The method of claim 1, wherein in the fourth step the third texture coordinates (U_{V}; V_{V}) are calculated by means of trilinear interpolation between second voxels (VX2).
